(19) United States
(12) Patent Application Publication
(10) Pub. No.: US 2019/0350805 A1
(43) Pub. Date: Nov. 21, 2019

(54) MOUTH AND ARM DEVICE FOR HORMONE RELEASE

(71) Applicant: Timothy D. Johnson, Bridgewater, NJ (US)

(72) Inventor: Timothy D. Johnson, Bridgewater, NJ (US)

(21) Appl. No.: 16/416,671

(22) Filed: May 20, 2019

Related U.S. Application Data
(60) Provisional application No. 62/673,882, filed on May 19, 2018.

(51) Int. Cl. A61H 39/04; A61H 1/00

(52) U.S. Cl. CPC A61H 39/04; A61H 2205/026; A61H 1/006

(57) ABSTRACT

A mouth and arm device and related method, for positioning a user's mouth and arms to facilitate physical poses for release of “feelgood” hormones to help alleviate depression made of a bite bar (1) for placement in the user's mouth, where the bite bar (1) has a central portion and a left side and a right side; two attachment portions (2) attached to each side of the bite bar and two arm components (6) connected thereto for positioning the user's arm in a physical pose while the user simultaneously bites down on the bite bar (1).

This application claims the benefit of U.S. provisional application Ser. No. 62/673,882 filed May 19, 2018 which is incorporated herein in its entirety by reference.

### FIELD OF THE INVENTION

The present invention relates to a bite bar device with two arm components extending therefrom for positioning user's mouth and arms to facilitate physical poses for release of “feelgood” hormones to help alleviate depression.

### BACKGROUND OF THE INVENTION

Depression is ubiquitous and can have devastating effects on individuals, families and society. It is also widespread, 1 out of 4 Americans in their 40's and 50's use antidepressants, and a staggering 1 in 10 Americans identify themselves as depressed.

Many patients fail pharmacologic treatment or suffer side effects of medications intended to improve patient's lives. The antidepressant market is a billion-dollar industry and is based on “soft science” with an extremely dangerous side effect profile. The number one side effect of most antidepressants is suicide. There is a need for a more holistic and natural approach to treat depression.

In a TED talk from March 2014 Amy Cuddy, the speaker, discussed how dopamine release leads to universal physical responses and that physical poses lead to dopamine release and improved mood. (See link—https://www.ted.com/talks/amy_cuddy_your_body_language_shapes_who_you_are)

As a survival mechanism, in the presence of something good, the brain releases four main ‘feelgood’ chemicals—endorphins, oxytocin, serotonin, and dopamine—and in the presence of danger, the ‘bad feeling’ chemical—cortisol—comes in.

Endorphins are natural pain and stress fighters. Endorphins are among the brain chemicals known as neurotransmitters, which function to transmit electrical signals within the nervous system. At least 20 types of endorphins have been demonstrated in humans.

Oxytocin is a peptide hormone and neuropeptide. Oxytocin is normally produced by the paraventricular nucleus of the hypothalamus and released by the posterior pituitary. It plays a role in social bonding, sexual reproduction in both sexes, and during and after childbirth.

Serotonin or 5-hydroxytryptamine (5-HT) is a monoamine neurotransmitter. Biochemically derived from tryptophan, serotonin is primarily found in the gastrointestinal tract (GI tract), platelets, and the central nervous system (CNS) of animals, including humans. It is popularly thought to be a contributor to feelings of well-being and happiness.

Dopamine is produced in several areas of the brain, including the substantia nigra and the ventral tegmental area. It is a neuro-hormone that is released by the hypothalamus. Its action is as a hormone that is an inhibitor of prolactin release from the anterior lobe of the pituitary. Dopamine also functions as a neurotransmitter in the brain. The brain includes several distinct dopamine pathways, one of which plays a major role in reward-motivated behavior.

Dopamine is the chemical that mediates pleasure in the brain and is responsible for reward seeking behavior. It is released during pleasurable situations and stimulates one to seek out the pleasurable activity or occupation.

The present invention, nicknamed H.O.P.E. for Holistic Option for Promoting Euphoria, was invented as a convenient, safe and accessible life hacking device to help individuals who struggle with depression.

Known prior inventions that induce smiling are costly and usually painful to the user. Both U.S. Pat. Nos. 9,737,377 and 5,556,357 disclose mouth guards.

In an Amour Bite Mouthpiece study from Nov. 3, 2011 it was shown that a mouthpiece significantly lowered an athlete's cortisol levels after exercise. (See www.bitetech.com/category/research). This research actually supports the assertion that the bite guard component does indeed release beneficial hormones to the user.

U.S. Patent Publication No. 2015/0238810 discloses a smile stick which is a device having a center bite bar section.

There are no known references that disclose a device that has a mouthpiece and an arm component extending therefrom for positioning and holding the user's arm in a victory pose for releasing “feelgood” hormones.

None of the currently available products provide a device consisting of a bite bar in combination with two arm components that extend to the user's arm length to each thumb. Each arm component accommodates each of the user's outstretched arms.

The device provides inspiration and relieves stress through the combination of two postures that lead to dopamine release and possibly other “feel good hormones”. The combination of poses is believed to lead to the same release of other “feel good hormones” such as endorphins, oxytocin and serotonin or alternatively provide a synergistic effect. It is known that physical poses lead to dopamine release and improved mood.

The invention device is intended to be a convenient, safe and accessible mood-altering device to help individuals who struggle with depression without the need for prescription medicines and without any adverse side effects. It is expected that the device will effect lives in a positive way.

Specifically, the device facilitates the user to hold their arms in a victory pose (the arm component) while forcing their faces into a smile (the bite bar component). The user places the bite bar component in their mouth with arms extended using the attached arm components which are preferably attached by adjustable toggles to each of the user's thumbs.

In various embodiments, variations in size of the bite bar as well as variations in materials are used.

The bite bar can be sanitized or can include a sanitary cover which can be removed and replaced or cleaned.

The invention is a safe and accessible device to help individuals in their journey towards happiness.

### SUMMARY OF THE INVENTION

In the present invention, these purposes, as well as others which will be apparent, are achieved generally by providing a mouth and arm device for hormone release comprising a bite bar 1 for placement in a user's mouth. The bite bar 1 has a central portion and a left side and a right side. The bite bar itself can vary in size and shape. Preferably the shape is either cylindrical or flat. The size varies depending on the individual but is preferably 3 to 8 inches, although other sizes are included in the scope of the invention.

There are two attachment portions 2. A first attachment portion is on the left side of the bite bar 1 and a second attachment portion is on the right side of the bite bar 1.

There are two arm components 6 for positioning the user's arm in a physical pose. The first arm component is connected to the first attachment portion on the left side of the bite bar 1 and a second arm component is connected to the second attachment portion on the right side of the bite bar 1.

In preferred embodiments the attachment portion 2 is a loop 3 and/or a hook 4.

Two thumb components 5 are attached to the first and second arm components. The thumb components are secured on a user's thumb to facilitate the “V” victory pose.

Preferably, the thumb components are toggles or buttons and are used to adjust the length of the first and second arm components to conform to the arm length of the user. This feature enables the device to be a one size fits all.

In preferred embodiments, the arm component 6 is a string that is double stranded. Other components are also part of the invention as long as they attach to the bite bar and extend the length of the user's arm to facilitate the arm poses.

All components of the device are made of materials selected from the group consisting of nylon, rubber, elastic, plastic, foam, synthetic and cotton.

The invention also includes a cover 7 for the bite bar 1. This cover can be removed and cleaned or sanitized.

The invention also includes a related method to release hormones in a user to alleviate depression comprising the steps of using the invention device described above. The user places the bite bar 1 in their mouth and places each of the thumb components 5 in the users left thumb and right thumb respectively. The user than extends the first and second arm components 6 from the first and second attachment portions 2 the full length of the user's arm such that the user extends their arms overhead and apart to make a V shape arm posture.

The user simultaneously bites down securely on the bite bar 1 creating a smile mouth posture. Together, the V shape arm posture and the smile mouth posture release hormones from the user's brain including dopamine to make the user feel happier.

The invention device provides inspiration and relieves stress through the combination of two postures that lead to dopamine release; specifically, the first pose is facilitating the user to hold their arms in a victory pose while forcing their faces into a smile. The second pose is the act of smiling.

Other objects, features, and advantages of the present invention will be apparent when the detailed description of the preferred embodiments of the invention are considered with reference to the drawings, which should be construed in an illustrative and not limiting sense.

### BRIEF DESCRIPTION OF THE DRAWINGS

FIG. 1 is an illustration of the bite bar 1 of the invention;

FIG. 2 is a close-up illustration of one of the attachment portions 2 used in the invention showing the loop 3 and hook 4 portions;

FIG. 3 is an illustration of the invention when not in use;

FIG. 4 is an illustration according to the invention showing the strings 6 extended from the toggles 2 on either side of the bite bar 1;

FIG. 5 is a close up of the components of the invention;

FIG. 6 is an illustration of the attachment portion 2 showing the arm component 6 secured to the attachment portion 2 of the bite bar 1; and

FIG. 7 is an illustration of the thumb component 5 and the arm component outstretched on the user's arm from the bite bar 1 (not seen in the drawing).

### DETAILED DESCRIPTION OF THE INVENTION

As used in the invention herein, the following numbers refer to the representative structures as illustrated in the drawings:
1—Bite bar
2—Attachment portion
3—Attachment portion—loop
4—Attachment portion—hook
5—Toggle or button
6—Arm Component
7—Cover for bite bar

The invention consists of a mouth and arm device made of a bite bar 1 having a central portion and a left and right side. When in use the bite bar is placed in the user's mouth between their teeth. The user bites down on the bar with their teeth and is held in place by the user's jaws. This posture causes the users facial muscles to form a smile.

Two attachment portions 2 are on the bite bar. A first attachment portion 2 is on the right side of the bite bar 1 and a second attachment portion is on the left side of the bite bar 1.

These attachment portions 2 are paired with and secured to two arm components 6 that extend to the user's arm length. Each arm component 6 accommodates the user's outstretched arms. A first arm component is connected to the first attachment portion on the left side of the bite bar. A second arm component is connected to the second attachment portion on the right side of the bite bar.

Arm components 2 include a variety of materials that can attach to the bite bar and extend the length of the user's arm. Such materials include wire, string, rubber resistance bands, tubing and the like, attached and extending from the bite bar 1. A preferred arm component is a light-weight string that is double stranded and preferably made of nylon, although other materials are within the scope of the invention.

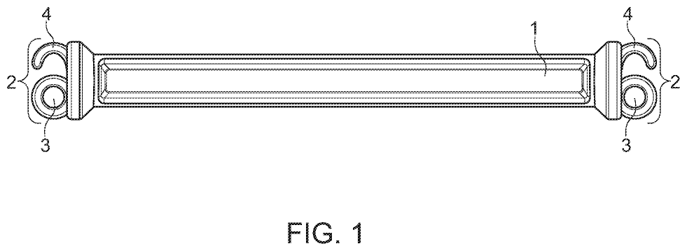

More specifically as shown in FIG. 1, the invention device is a mouth and arm device for hormone release made of a bite bar 1 and attachment portions 2 connected on either side of the bite bar 1.

In a preferred embodiment the attachment portions 2 each have a circular loop 3 and a curved open hook 4. In alternate embodiments, only the loop 3 or hook 4 is present.

In other embodiments, the arm components can be attached directly to the bite bar without an attachment component. For example, the arm component 6 can be attached directly to the bite bar itself.

The entire device is preferably one integral unit consisting of the bite bar 1 with two adjustable arm components 6 on either end.

The bite bar 1 can be covered with a plastic cover 7 for user comfort and cleanliness.

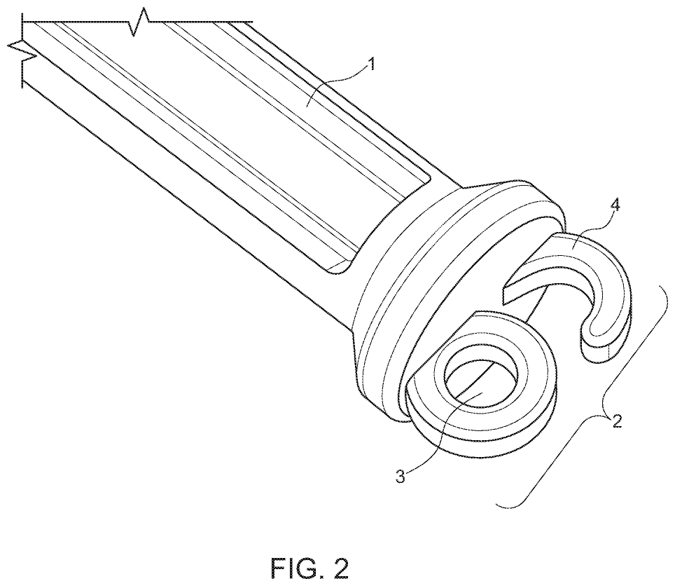

FIG. 2 shows a close-up of the attachment portions 2 in the embodiment having a loop 3 and hook 4. The loop is used to attach the arm components 6 on each side of the bite bar 1. In the embodiment where the arm component 6 is a string, the string is tied and secured to the loop. In this embodiment the string is double stranded so that at the opposite end of the bite bar a toggle is attached which can be secured to the user's thumb.

The hook is preferably a curved open hook and is used to secure the thumb toggles 5 on the device when not in use. The arm component 2 is also secured and wrapped on the bite bar 1 when not in use. It allows for the device to be compact and convenient when not in use.

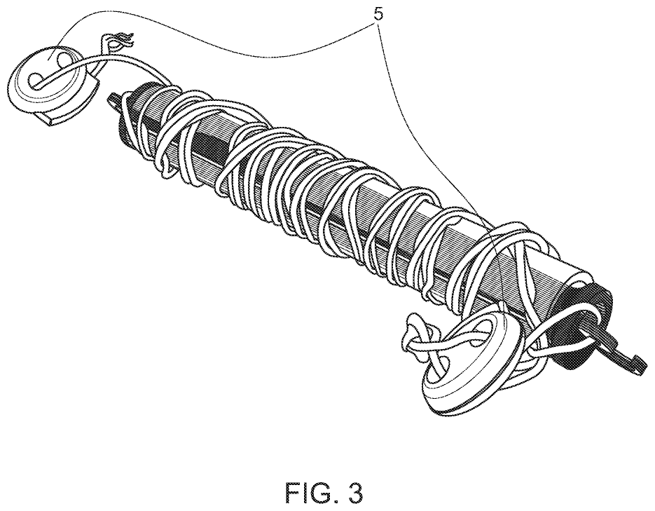

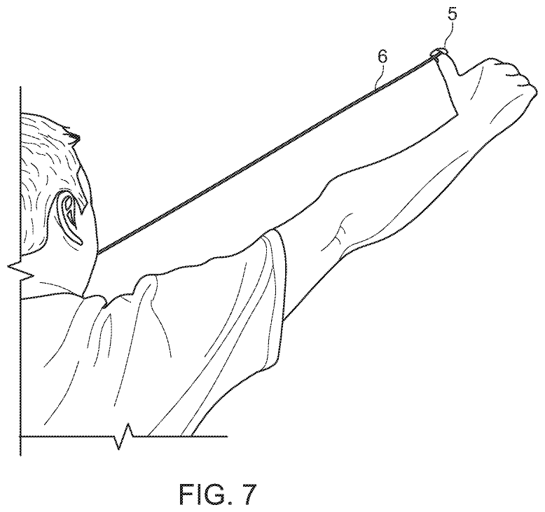

FIG. 3 illustrates the invention when not in use which is compact and easy to store and carry. The arm component 6 is wrapped around the bite bar 1. The toggles/buttons 5 are used to adjust the length of the arm component 6 to accommodate the length of a user's arm. It accommodates the variability of a user's wingspan. The user holds the arm component 6 by placing each of their thumbs in the curve of each arm component while extended. The toggle 5 rests on the user's thumb (shown in FIG. 7) when the arm component is in the outstretched position.

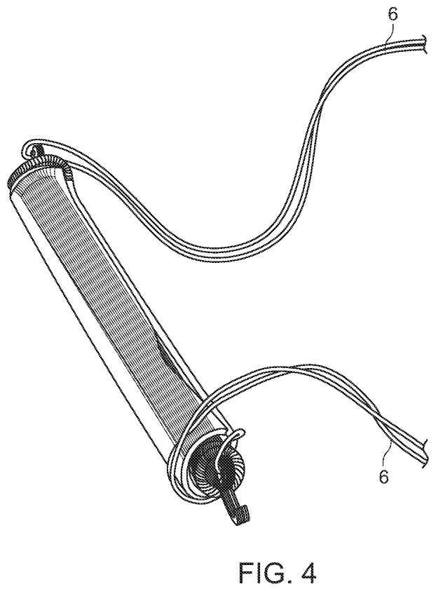

FIG. 4 illustrates the arm component 6 attached and extending from the bite bar 1.

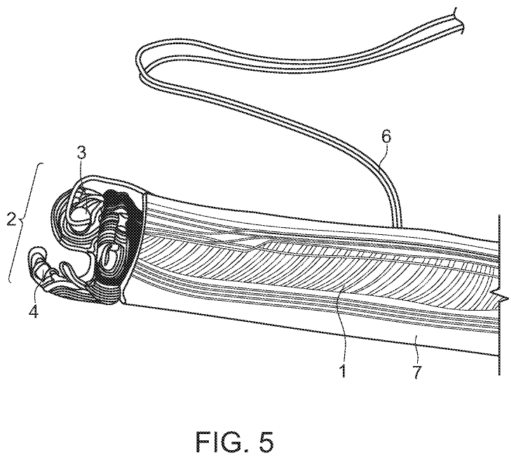

FIG. 5 is a close-up of the components of the invention. A plastic cover 7 can be placed over the bite bar 1. The cover 7 can be a clear medical grade plastic to protect the user's dentition from damage. The cover can also be removed and sanitized or replaced. The cover protects the bite bar too and prevents it from teeth mark damage.

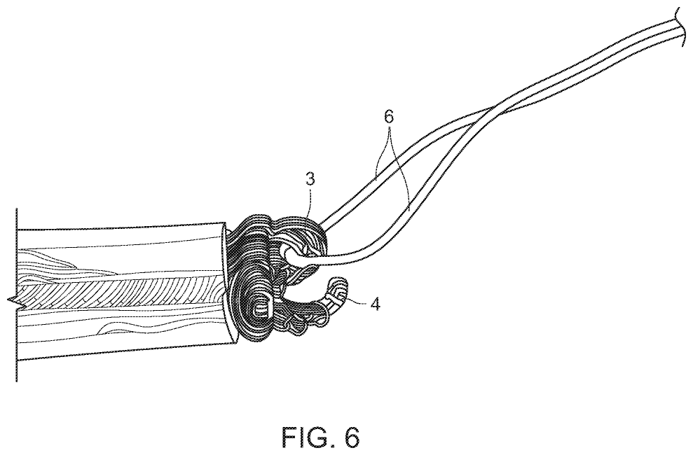

FIG. 6 is an illustration of the attachment portion 2 showing the embodiment where the arm component 6 secured to the loop 3 of the bite bar 1. This illustration shows the arm component 6 as a double stranded string tied and secured to the loop 3 of the bite bar.

FIG. 7 is an illustration of the thumb component 5 and the arm component outstretched on the user's arm from the bite bar 1 (not seen in the drawing). With the bite bar in the user's mouth, the user extends their arms with the thumb toggle 5 in the curve of the arm component 6.

The device is preferably made of plastic, but other materials safe for use in humans including rubber or synthetic materials can be used to make the device.

All components of the invention, the bite bar 1, the attachment portions 2, the arm components 6 and the thumb components 5 can be made from material selected from the group consisting of nylon, rubber, elastic, plastic, foam, synthetic and cotton.

The dimensions of the device, when in the closed position are approximately the size of a large pen and can vary depending on the user. Preferably 3 to 8 inches long, most preferably 4 to 7, and ¼ inch to 2 inches thick although other dimensions are within the scope of the invention.

The invention also provides a method to release hormones in a user to combat depression. FIG. 7 illustrates the device in full extension by the user in the victory pose. Once in this position, the user bites down on the bite bar which makes the user smile, which is the second pose.

The method steps include providing a mouth and thumb device comprising a bite bar 1; two attachments components 2 connected on either side of the bite bar with a loop 3 and a hook 4; and two arm component 6 attached to the attachment components, where the arm components each have a thumb toggle 5.

To use the device, the user places the bite bar 1 in the user's mouth and extends the arm component 6 the length of the user's arm, which in turn stretches the arm component.

The user bites down on the bite bar 1 and extends the arm components 6 to secure the toggles 5 on each thumb of the users. The user than raises their arms over head and apart to make a V shape posture, the first pose, such that the device is secure in the user's mouth and hands and releases hormones from the user's brain including dopamine to make the user feel happier. The bite bar is constructed such that it makes the user simile when they bite down on it, creating the second pose.

Preferably the user holds this position for a minimum of two minutes. They can rest and repeat for as often as they desire.

When fully extended, H.O.P.E the invention device will be in the user's mouth will have the bite bar in their mouth, and extended arms holding the string portion. The outstretched arms emphasize the victory pose.

Variations in the invention include the size of bite bar and materials used.

A bite bar that can be sanitized or has a sanitary cover is a possible variation.

The foregoing description of various and preferred embodiments of the present invention has been provided for purposes of illustration only, and it is understood that numerous modifications, variations and alterations may be made without departing from the scope and spirit of the invention as set forth in the following claims.

What is claimed is:

1. A mouth and arm device for positioning a user's mouth and arms comprising:
a bite bar (1) for placement in a user's mouth, wherein said bite bar (1) has a central portion and a left side and a right side;
two attachment portions (2), wherein a first attachment portion is on said left side of said bite bar (1) and a second attachment portion is on said right side of said bite bar (1);
and two arm components (6) for positioning the user's arm in a physical pose; wherein a first arm component is connected to said first attachment portion on said left side of said bite bar (1) and a second arm component is connected to said second attachment portion on said right side of said bite bar (1).

2. The mouth and arm device according to claim 1, wherein said attachment portion (2) is a loop (3).

3. The mouth and arm device according to claim 1, wherein said attachment portion (2) is a hook (4).

4. The mouth and arm device according to claim 1, further comprising two thumb components (5) attached to said first and second arm components; wherein said thumb components are secured on a user's thumb.

5. The mouth and arm device according to claim 4, wherein said thumb components are toggles used to adjust the length of said first and second arm components.

6. The mouth and arm device according to claim 1, wherein said bite bar (1) is a cylindrical bar.

7. The mouth and arm device according to claim 1, wherein said bite bar (1) is a flat bar.

8. The mouth and arm device according to claim 1, wherein said arm component (6) is a string.

9. The mouth and arm device according to claim 1, wherein said arm components (6) are made of a material selected from the group consisting of nylon, rubber, elastic, plastic, foam, synthetic and cotton.

10. The mouth and arm device according to claim 1, wherein said bite bar (1) is made of a material selected from the group consisting of nylon, rubber, elastic, plastic, foam, synthetic and cotton.

11. The mouth and arm device according to claim 1, wherein said attachment portions (2) are made of a material selected from the group consisting of nylon, rubber, elastic, plastic, foam, synthetic and cotton.

12. The mouth and arm device according to claim 1, further comprising a cover (7) for said bite bar (1).

13. A method to release hormones in a user to alleviate depression comprising the steps of:
providing a mouth and arm device comprising a bite bar (1) having a left side and a right side; two attachment portions (2), wherein a first attachment portion is on said left side of said bite bar (1) and a second attachment portion is on said right side of said bite bar (1); and two arm components (6); wherein a first arm component is connected to said first attachment portion on said left side of said bite bar (1) and a second arm component is connected to said second attachment portion on said right side of said bite bar (1); and two thumb components (5) attached to said first and second arm components;
placing said bite bar (1) in the user's mouth;
placing each of said thumb components (5) in the users left thumb and right thumb respectively;
extending said first and second arm components (6) from said first and second attachment portions (2) the full length of the user's arm such that the user extends their arms overhead and apart to make a V shape arm posture;
simultaneously while the user bites down securely on said bite bar (1) creating a smile mouth posture;
wherein said V shape arm posture and said smile mouth posture release hormones from the user's brain including dopamine to make the user feel happier.

14. The method according to claim 13, wherein said attachment portion (2) is a loop (3) and said arm components (6) are secured to said loop (3).

15. The method according to claim 13, wherein said attachment portion (2) is a hook (4) and said thumb components (5) are secured to said hook (4) when not in use by the user.

16. The method according to claim 13, wherein said thumb components are toggles which are used to adjust the length of said first and second arm components to the arm length of the user.

17. The method according to claim 13, further comprising a cover (7) for said bite bar (1), wherein said cover (7) is removed and sanitized after use.

18. The method according to claim 13, wherein said arm components (6) are made of a material selected from the group consisting of nylon, rubber, elastic, plastic, foam, synthetic and cotton.

19. The method according to claim 13, wherein said bite bar (1) is made of a material selected from the group consisting of nylon, rubber, elastic, plastic, foam, synthetic and cotton.

20. The method according to claim 13, wherein said attachment portions (2) are made of a material selected from the group consisting of nylon, rubber, elastic, plastic, foam, synthetic and cotton.
